(19) United States
(12) Patent Application Publication
(10) Pub. No.: US 2024/0351301 A1
(43) Pub. Date: Oct. 24, 2024

(54) METHOD AND TUBULAR BAG MACHINE FOR THE CONTINUOUS PRODUCTION OF BLOCK-BOTTOM BAGS

(71) Applicant: ROVEMA GMBH, Fernwald (DE)

(72) Inventor: Gunter BRUECK, Reiskirchen (DE)

(73) Assignee: ROVEMA GMBH, Fernwald (DE)

(21) Appl. No.: 18/683,433

(22) PCT Filed: Jul. 19, 2022
(86) PCT No.: PCT/EP2022/070129

§ 371 Date: Feb. 13, 2024

(30) Foreign Application Priority Data
Aug. 18, 2021 (DE) 10 2021 121 409.2

(51) Int. Cl. B31B 70/64; B31B 70/26; B31B 70/52; B31B 160/20

(52) U.S. Cl. CPC B31B 70/645; B31B 70/261; B31B 70/52; B31B 70/642; B31B 2160/20

(57) ABSTRACT

The invention relates to a tubular bag machine and a method for the continuous production of block-bottom bags (10) comprising two side areas folded in at the bottom and a transversally sealed bottom seam, the bottom seam comprising at least one first portion with a twin film web and at least one second portion with a quadruple film web, and the bottom seam running in the base surface des block-bottom bag (10). Once a bottom seam has been transversally sealed, the front block-bottom bag (10) is severed from the film web (03) by applying a film cut, and the transverse sealing jaws (09) moving in the conveying direction are opened far enough for the transverse sealing jaws (09) to exert essentially no more pressure on the bottom seal, and the transverse sealing jaws (09) moving in the conveying direction simultaneously move perpendicular to the conveying direction, the bottom seam thus being folded over perpendicular to the conveying direction, and the folded-over bottom seam is fixed in such a manner that it runs in the base surface of the block-bottom bag (10)

The invention relates to a method for the continuous production of block-bottom bags having two side areas folded in at the bottom. Furthermore, the invention relates to a tubular bag machine for carrying out the method according to the invention.

A tubular bag machine for producing block-bottom bags is known, for example, from DE 10 2010 028 607 A1. The tubular bag machine may basically be a vertically or horizontally operating tubular bag machine, meaning the tubular bags are conveyed either vertically or horizontally through the tubular bag machine. The tubular bag machine is used to produce block-bottom bags using a film material. The block-bottom bags are formed by producing sealed seams using the tubular bag machine. The block-bottom bags are characterized by having two side areas folded in at the bottom to form a base surface at the bottom of the block-bottom bag. When sealing the bottom seam, the film web is folded in so that the sealed seam comprises a first portion with a twin film web and at least one second portion with a quadruple film web.

In the case of the known block-bottom bags, it is often necessary that they are not filled while still in the tubular bag machine immediately after the block-bottom bag has been formed. Instead, empty bags are first produced, which are then filled with a product in another machine unit and then closed by forming a top seam. Since the empty bags are not filled, they tend to fall over very easily, causing disruptions in the machine process. This tendency of the unfilled block-bottom bags to fall over is particularly pronounced if the bottom mat does not lie flat against the base surface of the block-bottom bag but instead protrudes at a certain angle.

Based on this state of the art, it is therefore the object of the present invention to propose a new method for the continuous production of block-bottom bags where the block-bottom bags have a high stability even in the unfilled state and machine malfunctions are thereby avoided. Furthermore, the object of the present invention is to propose a tubular bag machine for carrying out the method according to the invention. The method for continuous production according to the invention is generically characterized first of all by the fact that the transverse sealing jaws are moved in the conveying direction, allowing them to engage the film web in order to seal the transverse seams without stopping the film web. The method according to the invention provides that the tubular bag produced last is first severed from the film web by applying a film cut. The transverse sealing of the transverse sealing seam required is already completed by pressing the two transverse sealing jaws together.

While the transverse sealing jaws are still being moved in the conveying direction to enable the continuous production of the block-bottom bags, the transverse sealing jaws are opened to such an extent that they essentially no longer exert any pressure on the bottom seam. A slight pressure of the transverse sealing jaws on the bottom seam below a certain tolerance threshold does not interfere with this.

Subsequently, the transverse sealing jaws, which continue to move in the conveying direction, are immediately moved perpendicular to the conveying direction, as well, causing the bottom seam to be folded over perpendicular to the conveying direction and at least partially approach the base surface of the block-bottom bag. Finally, the folded-over bottom seam is then fixed in such a manner that it runs in the base surface of the block-bottom bag.

So, as a result, the transverse movement of the transverse sealing jaws during the continuous conveying of the tubular bag allows the bottom seam to be folded over and then fixed to the base surface, which significantly increases the stability of the still empty block-bottom bags. The bottom seam can be folded over either to the left or to the right relative to the pivot point of the bottom seam.

The bottom seam can basically be fixed to the base surface of the block-bottom bag in any manner. Fixation can be achieved particularly reliably and simply if the folded-over bottom seam is at least partially sealed to the base surface of the block-bottom bag. For example, the bottom seam can be sealed to the base bottom in spots or across its entire surface.

The bottom seam can be sealed to the base surface of the block-bottom bag by applying sealing pressure with a sealing tool but without introducing additional heat beforehand, as in most cases there is sufficient heating of the film web in the area of the portion to be sealed to the base surface. By dispensing with the supply of additional heat when sealing the bottom seam to the base surface, machine complexity is considerably reduced. The block-bottom bag may basically have any shape otherwise. Since the invention has a particularly great advantage in the field of the production of empty bags, it is particularly advantageous if the block-bottom bags have an opening opposite the base surface, the opening allowing the block-bottom bag to be subsequently filled in the same or a downstream machine. If necessary, however, the bottom seam to be sealed to the base surface can also be heated.

The film web itself can basically made of any material. The method according to the invention is particularly pertinent if the film web comprises a paper layer to which the sealing layer is attached. Since the paper layer itself cannot be sealed and the sealing layer should be as thin as possible with regard to the recycling of the block-bottom bag, the bottom seam of such paper block-bottom bags may stand away excessively if the bottom seam is not fixed.

The teaching according to the invention is particularly pertinent if the film web contains a paper content of more than 95%. While tubular bags of this kind, which are essentially made exclusively from paper, are very easy to recycle, they have so far presented major problems with regard to the stability of empty bags because their bottom seam tends to stand away.

To carry out the method according to the invention, a generic tubular bag machine having a conventional structure and being suitable for the continuous production of block-bottom bags can be used. According to the invention, this tubular bag machine is enhanced in that the tubular bag machine comprises a docking stamp whose stamp surface can be brought into contact with the inner side of the base surface of a block-bottom bag. The pressing stamp is configured to simultaneously be driven in the conveying direction by a drive in order to be able to follow the base surface of the tubular bag during the continuous conveying of the tubular bag. During the movement, the pressing stamp is pressed against the inner side of the base surface of the block-bottom bag with a predetermined pressure as the tubular bag is continuously conveyed so that the bottom seam previously folded over is fixed in, in particular sealed to, the base surface.

Preferably, the pressing stamp can be a sealing stamp in order to be able to seal the flattened bottom seam in the base surface of the block-bottom bag.

A particularly simple structure of the tubular bag machine is achieved if the sealing stamp is a forming tube. In this way, the filling material can be filled into the block-bottom bag through the sealing stamp and the film web can be guided on the outer side of the sealing plunger at the same time.

The tubular bag machine preferably comprises a folding mechanism to achieve the folding of the bottom seam initially still standing away.

A particularly simple structure of the tubular bag machine comprising a folding mechanism is achieved if the folding mechanism is a shifting mechanism by means of which the two transverse sealing jaws moving in the conveying direction can simultaneously be shifted perpendicular to the conveying direction. Structurally, this position of the transverse sealing jaws perpendicular to the conveying direction can be realized by pressing the two transverse sealing jaws against each other using a toggle drive, the shifting mechanism shifting the core point of the toggle drive perpendicular to the conveying direction.

An embodiment of the invention is schematically illustrated in the drawings and is explained below by way of example.

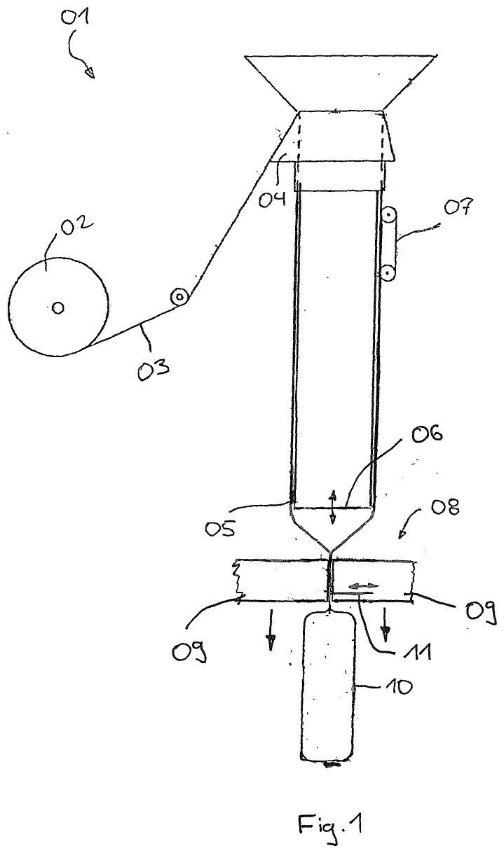

FIG. 1 is a side view of a schematically illustrated tubular bag machine for carrying out the method according to the invention;

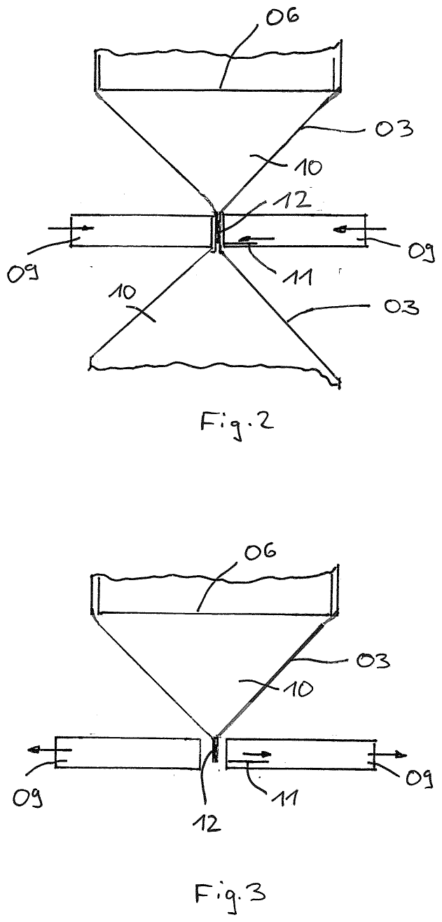

FIG. 2 shows the transverse sealing jaws of the tubular bag machine of FIG. 1 in a first stage of the method according to the invention;

FIG. 3 shows the transverse sealing jaws of the tubular bag machine of FIG. 1 in a second stage of the method according to the invention;

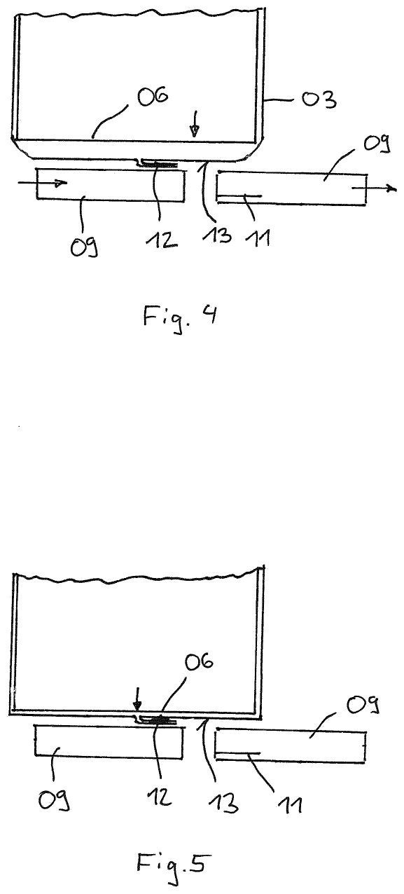

FIG. 4 shows the transverse sealing jaws of the tubular bag machine of FIG. 1 in a third stage of the method according to the invention;

FIG. 5 shows the transverse sealing jaws of the tubular bag machine of FIG. 1 in a fourth stage of the method according to the invention.

FIG. 1 shows a schematically illustrated tubular bag machine 01, only the parts of the tubular bag machine 01 that are necessary for understanding the invention being shown in FIG. 1. A film web 03 is unwound from a supply roll 02 and then shaped into a film tube on a shaping shoulder 04. The film web 03 is a paper web coated with a sealing layer, the paper content being higher than 95%.

The film tube 05, which is driven by a film drive 07, slides downward on the outside of the forming tube 06, the film tube 05 being sealed longitudinally parallel to its conveying direction by means of a longitudinal sealing mechanism (not shown in FIG. 1). The conveying speed of the film web 03 is monitored by a suitable sensor system. The forming tube 06 is designed in the manner of a sealing stamp at its end face and can be moved upward or downward in the direction of the conveying direction of the film web 03 by means of a drive (not shown). The function of the sealing stamp in the forming tube 06 is explained in more detail below.

Below the forming tube 06 there is a transverse sealing mechanism 08 having two transverse sealing jaws 09 for producing transverse sealing seams and serving to transversally seal the film tube 05 to form individual tubular bags 10. In addition, the tubular bag machine 01 comprises two folding plates (not shown in FIG. 1) configured to fold the film web 03 in laterally to produce a block-bottom bag. A severing member 11 designed as a severing knife is integrated into the right-hand transverse sealing jaw 09 and allows the tubular bags to be separated from each other after the transverse sealing seam has been applied.

The tubular bag machine 01 shown in FIG. 1 can be used to produce unfilled block-bottom bags 10 which initially do not yet have a top seam. These unfilled block-bottom bags can then be filled with a product in a subsequent process stage and then sealed by applying a top seam.

FIG. 2 shows the transverse sealing jaws 09 and the tubular bag 10 during the transverse sealing of the bottom seam 12. The two transverse sealing jaws 09 are moved downward at essentially the same conveying speed as the conveying speed of the film web 03, and the transverse sealing jaws 09 are pressed against each other at the same time using a toggle drive. By heating the transverse sealing jaws 09, the film web 03 is then sealed to produce the bottom seam 12. Subsequently, the severing member 11 is deployed and the lowest block-bottom bag 10 is cut off.

FIG. 3 shows the transverse sealing jaws 09 in the subsequent process phase after the lowermost block-bottom bag has been cut off. As soon as the bottom seam 12 is sufficiently sealed, the transverse sealing jaws 09 are moved a little further apart, continuing to move downward at the conveying speed of the film web 03. In this way, the bottom seam 12 is released.

Then, as shown in FIG. 4, the core point of the toggle drive is moved sideways to drive the two transverse sealing jaws 09, the distance between the two transverse sealing jaws 09 remaining the same. By moving the left transverse sealing jaw 09 sideways, the bottom seam 12 is folded over and lies flat against the outer side of the film web 03 at the base surface 13. At the same time, the forming tube 06, which is also a sealing stamp, is moved downwards, the travel speed of the forming tube 06 being greater than the speed of the two transverse sealing jaws 09. In this manner, the lower end face of the forming tube 06 approaches the upper side of the transverse sealing jaws 09.

As can be seen in FIG. 5, the forming tube 06 is finally pressed against the upper side of the base surface 13 from above so that the bottom seam 12 is partially sealed between the end face of the forming tube 06 and the upper side of the left transverse sealing jaw 09. A supply of thermal energy is not necessary, as there is still sufficient residual heat in the bottom seam 12. The pressure of the forming tube 06 against the bottom seam 12 causes the bottom seam 12 to be slightly sealed to the base surface 13 of the tubular bag 10.

1. A method for the continuous production of block-bottom bags (10) comprising two side areas folded in at the bottom and a transversally sealed bottom seam (12), the bottom seam (12) comprising at least one first portion with a twin film web and at least one second portion with a quadruple film web, and the bottom seam (12) running in the base surface (13) of the block-bottom bag (10),
characterized in that
a) once a bottom seam (12) has been transversally sealed, the front block-bottom bag (10) is severed from the film web (03) by applying a film cut;
b) the transverse sealing jaws (09) moving in the conveying direction are opened far enough for the transverse sealing jaws (09) to exert essentially no more pressure on the bottom seam (12);
c) the transverse sealing jaws (09) moving in the conveying direction simultaneously move perpendicular to the conveying direction, the bottom seam (12) thus being folded over perpendicular to the conveying direction;
d) the folded-over bottom seam (12) is fixed in such a manner that it runs in the base surface (13) of the block-bottom bag (10).

2. The method according to claim 1,
characterized in that
the folded-over bottom seam (12) moving in the conveying direction is at least partially sealed to the base surface (13) of the block-bottom bag (10).

3. The method according to claim 2,
characterized in that
the bottom seam (12) is sealed by applying a sealing pressure using a sealing tool without any additional heat input.

4. The method according to claim 1,
characterized in that
the block-bottom bags (10) have an opening opposite the inner side of the base surface (13), the opening allowing the block-bottom bag to be subsequently filled.

5. The method according to claim 1,
characterized in that
the film web (03) used for producing the block-bottom bags (10) comprises a paper layer to which the sealing layer is attached.

6. The method according to claim 5,
characterized in that
the film web (03) used for producing the block-bottom bags (10) contains a paper content of at least 95%.

7. A tubular bag machine (01) comprising a film web (03) configured to be unwound from a supply roll (02), a shaping shoulder (04) for shaping the film web (03) into a film tube (05), a longitudinal sealing mechanism for sealing the film tube (05) along a longitudinal seam, and a transverse sealing mechanism (08) having transverse sealing jaws (09) for producing bottom seams (12), the transverse sealing jaws (09) being configured to move against each other and transversally seal the film tube (05), characterized in that
the tubular bag machine (01) comprises a pressing stamp whose stamp surface is configured to come into contact with the inner side of the base surface (13) of a block-bottom bag (10), the pressing stamp being configured to be driven in the conveying direction by a drive, and the pressing stamp being configured to be pressed against the inner side of the base surface (13) of the block-bottom bag (10) with a predefined pressure during the movement.

8. The tubular bag machine according to claim 7,
characterized in that
the pressing stamp is a sealing stamp.

9. The tubular bag machine according to claim 8,
characterized in that
the sealing stamp is a forming tube (06), the film web (03) being guided on the outer side of the forming tube (06).

10. The tubular bag machine according to claim 7,
characterized in that
the tubular bag machine comprises a folding mechanism configured to fold the bottom seam (12) over perpendicular to the conveying direction.

11. The tubular bag machine according to claim 10,
characterized in that
the folding mechanism is a shifting mechanism configured to simultaneously shift the transverse sealing jaws (09) perpendicular to the conveying direction as they are moving in the conveying direction.

12. The tubular bag machine according to claim 11,
characterized in that
the two transverse sealing jaws (09) are configured to be pressed against each other by a toggle drive, the shifting mechanism being configured to shift the core point of the toggle drive perpendicular to the conveying direction.

13. The method according to claim 1,
characterized in that
the folded-over bottom seam (12) moving in the conveying direction is at least partially sealed to the base surface (13) of the block-bottom bag (10);
the bottom seam (12) is sealed by applying a sealing pressure using a sealing tool without any additional heat input;
the block-bottom bags (10) have an opening opposite the inner side of the base surface (13), the opening allowing the block-bottom bag to be subsequently filled;
the film web (03) used for producing the block-bottom bags (10) comprises a paper layer to which the sealing layer is attached;
the film web (03) used for producing the block-bottom bags (10) contains a paper content of at least 95%.

14. The tubular bag machine according to claim 7,
characterized in that
the pressing stamp is a sealing stamp;
the sealing stamp is a forming tube (06), the film web (03) being guided on the outer side of the forming tube (06);
the tubular bag machine comprises a folding mechanism configured to fold the bottom seam (12) over perpendicular to the conveying direction;
the folding mechanism is a shifting mechanism configured to simultaneously shift the transverse sealing jaws (09) perpendicular to the conveying direction as they are moving in the conveying direction;
the two transverse sealing jaws (09) are configured to be pressed against each other by a toggle drive, the shifting mechanism being configured to shift the core point of the toggle drive perpendicular to the conveying direction.
